(19) United States
(12) Patent Application Publication
(10) Pub. No.: US 2007/0088979 A1
(43) Pub. Date: Apr. 19, 2007

(54) Hardware configurable CPU with high availability mode

(76) Inventors: Ken Gary Pomaranski, Roseville, CA (US); Andrew Harvey Barr, Roseville, CA (US); Dale John Shidla, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/251,019

(22) Filed: Oct. 14, 2005

(51) Int. Cl. G06F 11/00

(52) U.S. Cl. 714/10

(57) ABSTRACT

A microprocessor includes a plurality of execution units of a same type, and a first register operable to select between a first and a second mode of operation, wherein the microprocessor utilizes at least one of the execution units as a redundant execution unit during the first mode of operation and utilizes none of the execution units as a redundant execution unit during the second mode of operation.

### BACKGROUND

As more and more transistors are placed on central processing unit (CPU) chips with smaller and smaller feature sizes and lower voltage levels, the need for on-chip fault-tolerance features is increased. In particular, CPU execution units, such as floating point units (FPUs), are especially susceptible to potential failure mechanisms because they take up large areas of the CPU.

Typically, error correction coding (ECC) may be used to detect and correct errors. ECC provides single-bit and multi-bit error detection, and also provides single-bit error correction. However, ECC requires a setting in a computer system's BIOS utility program to be enabled as well as special chipset support. In addition, it is often difficult to implement ECC through CPU execution units such as FPUs.

One conventional solution for providing fault-tolerance in digital processing by CPUs is using a computer system with multiple CPUs. For example, the multiple CPUs may be operated in full lock-step to achieve a level of fault-tolerance in their computations. That is, multiple CPUs each execute the same computation and then the results are compared to determine if an error has occurred. However, such a solution may not only waste hardware from a performance perspective, but is also often expensive in that it typically requires additional hardware and support infrastructure and consumes more power.

Another conventional solution for providing fault-tolerance in digital processing by CPUs is software verification. The software verification is performed by executing an entire program multiple times on the same computer or on different computers, and then comparing the results for errors. However, this solution is often expensive in that it requires a longer run-time or requires multiple computers.

Other solutions address the problem by having a program compiler schedule redundant execution unit operations in the CPU at compile time to compare and test the results from the execution units for errors. However, these solutions often require the use of a special compiler; therefore, code compiled with a different compiler often must be recompiled with the special compiler. In addition, these solutions require that code be recompiled before the computer can take advantage of the additional fault-tolerance. This not only requires a longer run-time due to the scheduling of redundant execution unit operations and the recompiling of code, but it also requires additional hardware such as the special compiler.

Furthermore, comparison of the outputs of the execution units in the above solutions typically sacrifices performance in all cases, even in those programs that do not require fault-tolerance. This is because the above solutions typically provide fault-tolerance for every instruction of every program that is run on the computer system. As a result, the entire computer system is unnecessarily slowed down because programs that do not require fault-tolerance are being run with fault-tolerance.

### SUMMARY

An embodiment of the invention provides a microprocessor including a plurality of execution units of a same type, and a first register operable to select between a first and a second mode of operation, wherein the microprocessor utilizes at least one of the execution units as a redundant execution unit during the first mode of operation and utilizes none of the execution units as a redundant execution unit during the second mode of operation.

### BRIEF DESCRIPTION OF THE DRAWINGS

FIG. 1 is a diagram of a computer in which an embodiment of the invention may be used.

FIG. 2 is a block diagram of a portion of a microprocessor according to a first embodiment of the invention.

FIG. 3 is a block diagram of a portion of a microprocessor according to a second embodiment of the invention.

### DETAILED DESCRIPTION

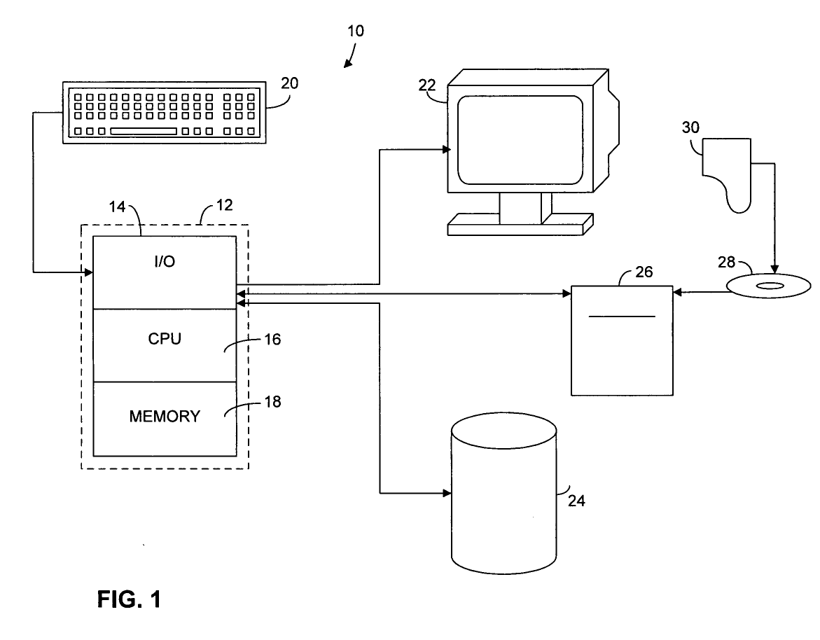

FIG. 1 is a diagram of a computer 10 in which an embodiment of the invention may be used. The computer 10 may be any type of general-purpose computer, workstation or personal computer, and may include a computing circuit 12 having an input/output (I/O) portion 14, a microprocessor or CPU 16, and a memory 18. The I/O portion 14 is connected to a keyboard and/or other input devices 20, a display and/or other output devices 22, one or more permanent storage units 24, such as a hard drive, and/or removable storage units 26, such as a CD-ROM drive. The removable storage unit 26 may read a data storage medium 28, which typically contains software programs 30 and other data.

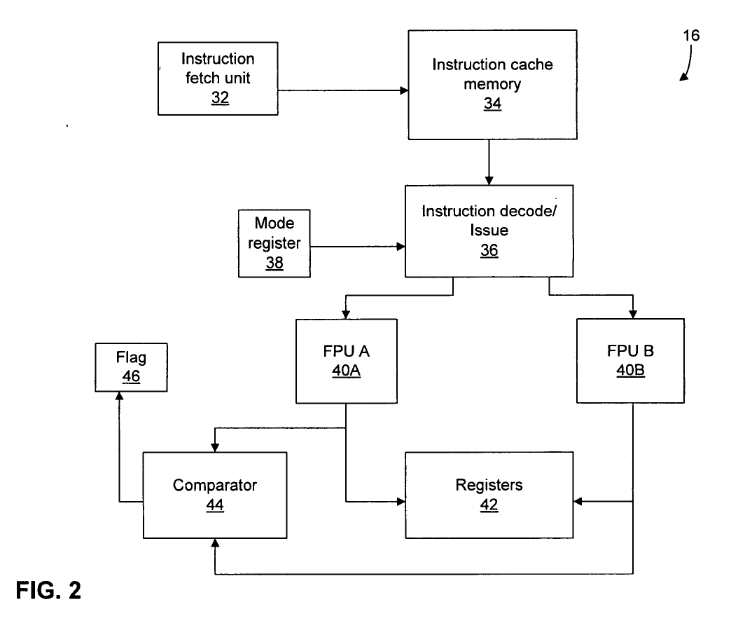

FIG. 2 is a block diagram of a portion of the microprocessor 16 of FIG. 1 according to a first embodiment of the invention. The microprocessor 16 includes a mode register 38 that is used to selectively turn on and off fault-tolerance features within the microprocessor 16 by setting a value in the mode register. The mode register 38 allows the microprocessor 16 to operate in a fault-tolerant mode when a program requires fault-tolerance, and operate in a performance mode when a program does not require fault-tolerance. As a result, the microprocessor 16 is able to increase the fault-tolerance of a computer system without unnecessarily slowing the computer system down. This is accomplished without the expense of additional microprocessors, special compilers, or longer run-times.

The components shown in FIG. 2 for explanatory purposes include an instruction fetch unit 32, an instruction cache memory 34, an instruction decode/issue 36, the mode register 38, execution units (FPUs) 40A and 40B, registers 42, a comparator 44, and a comparison flag 46. The configuration of these components in FIG. 2 is just one example configuration, and an actual microprocessor typically has numerous other portions that are not shown. While the configuration shown in FIG. 2 has two FPUs 40A and 40B, other configurations may also be implemented on microprocessors with more than two FPUs, or with execution units other than FPUs.

The instruction cache 34 stores instructions that are frequently being executed by the microprocessor 16. Similarly, a data cache (not shown) may store data that is frequently being accessed by the microprocessor 16 to execute the instructions. In some implementations, the instruction and data caches may also be combined into one memory. There is also typically access (not shown) by the microprocessor 16 to random access memory (RAM), disk drives, and other forms of digital storage.

Addresses of instructions in memory may be generated by the instruction fetch unit 32. For example, the instruction fetch unit 32 may include a program counter that increments from a starting address within the instruction cache 34 serially through successive addresses in order to read out instructions stored at those addresses. The instruction decode/issue 36 receives instructions from the cache 34 and decodes and/or issues the instructions to one or both of the FPUs 40A and 40B for execution. The mode register 38 determines in which mode the microprocessor 16 is operating. The FPUs 40A and 40B may be configured to output the results of the execution to specific registers 42 in the microprocessor 16. In addition, the outputs of the FPUs 40A and 40B are coupled to a comparator 44. The comparator 44 compares the values at its two inputs and then outputs a value to the comparison flag 46, which indicates whether the input values are the same or different. Other circuitry, such as that to supply operands for the instruction execution, is not shown.

In accordance with an embodiment of the invention, the circuitry of FIG. 2 utilizes the mode register 38 to selectively turn on and off fault tolerant operations within the microprocessor 16. In other words, the mode register 38 selectively configures the microprocessor 16 to run in either a performance mode (fault-tolerant operations turned off) or a fault-tolerant mode (fault-tolerant operations turned on). The fault-tolerant mode may also be referred to as a high availability (HA) mode.

For example, when the mode register 38 is set to a first value (e.g., a logic “0”), the microprocessor 16 operates in the performance mode where all fault-tolerant operations are turned off to maximize the speed of the microprocessor 16. In this mode, the comparator 44 and the comparison flag 46 are deactivated, and the microprocessor 16 utilizes both FPUs 40A and 40B as scheduled by a program compiler (not shown). The instruction decode/issue 36 may issue a first instruction to only the FPU 40A during a clock cycle, or the instruction decode/issue 36 may issue first and second instructions in parallel to both of the FPUs 40A and 40B during a clock cycle. The outputs of the FPUs 40A and 40B may then be retired without having to wait for the comparator 44 or the comparison flag 46.

Alternatively, when the microprocessor 16 is operating in the performance mode, the comparator 44 and the comparison flag 46 may be activated. In this case, the instruction decode/issue 36 still utilizes both FPUs 40A and 40B as scheduled by the compiler. However, the microprocessor 16 simply ignores any results from the comparator 44 and does not perform any type of error comparison before retiring the outputs of the FPUs 40A and 40B. As a result, there is no degradation in the speed of the microprocessor 16.

When the mode register 38 is set to a second value (e.g., a logic “1”), the microprocessor 16 operates in the HA mode where fault-tolerant operations are turned on to increase the fault-tolerance of the microprocessor 16. In this mode, the comparator 44 and the comparison flag 46 are activated, and the FPU 40B now functions as a redundant execution unit parallel to the FPU 40A. As a result, if the compiler schedules a first instruction to be executed by the microprocessor 16, the instruction decode/issue 36 issues the first instruction to the FPU 40A and also to the redundant FPU 40B. That is, both the FPU 40A and the FPU 40B execute the same instruction. The comparator 44 then compares the outputs of the FPUs 40A and 40B so that if the outputs match, then the comparator 44 provides a signal to the comparison flag 46 indicating that the result is correct, and the outputs of the FPUs are retired. If the outputs of the FPUs 40A and 40B do not match, then the comparator 44 provides a signal to the comparison flag 46 indicating that there is an error. At this point, the instruction from the instruction decode/issue 36 may be re-executed by the FPUs 40A and 40B until the FPU results match.

Alternatively, if the compiler schedules first and second instructions to be executed in parallel by the microprocessor 16 in the HA mode, then the instruction decode/issue 36 issues the first instruction to both the FPU 40A and the redundant FPU 40B during a first clock cycle and the comparator 44 compares the outputs of the FPUs. Then immediately afterwards, the instruction decode/issue 36 issues the second instruction to both the FPU 40A and the redundant FPU 40B during a second clock cycle and the comparator 44 compares the outputs of the FPUs.

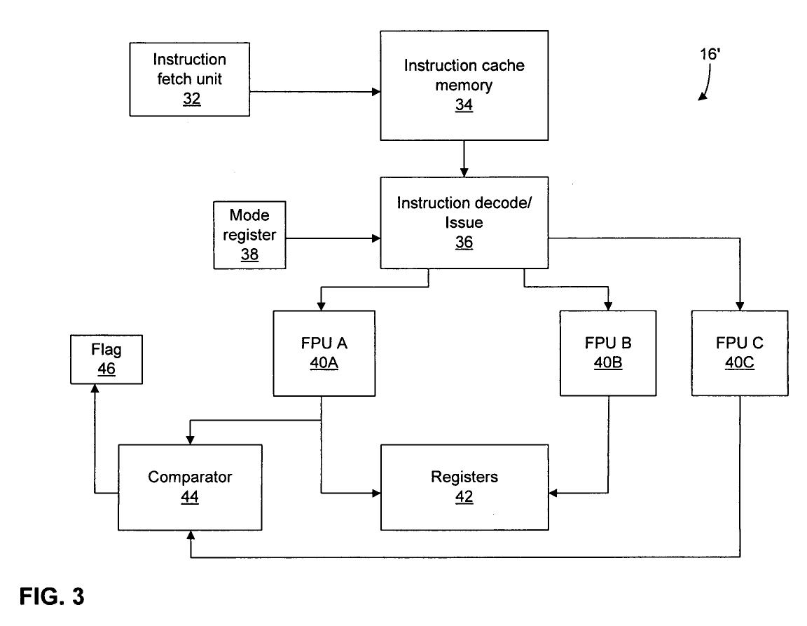

FIG. 3 is a block diagram of a portion of a microprocessor 16′ according to a second embodiment of the invention. The microprocessor 16′ is similar to the microprocessor 16 in FIG. 2. However, the microprocessor 16′ includes at least one additional FPU 40C that is activated as a redundant FPU when the microprocessor 16′ is operating in the HA mode and is deactivated when the microprocessor 16′ is operating in the performance mode. The redundant FPU 40C is “known” only to the microprocessor 16′ and is “invisible” to the program compiler (not shown). In this way, the FPU 40C is always available to the microprocessor 16′ to perform redundant calculations, while the compiler has full access to the FPUs 40A and 40B. An advantage of the microprocessor 16′ over the microprocessor 16 in FIG. 2 is that the FPUs 40A and 40B are often able to execute different instructions in parallel during a single clock cycle even when the microprocessor 16′ is operating in the HA mode.

Alternatively, the redundant FPU 40C, the comparator 44 and the comparison flag 46 may also be activated when the microprocessor 16′ is operating in the performance mode. In this case, the instruction decode/issue 36 still utilizes the redundant FPU 40C along with the FPUs 40A and 40B. However, the microprocessor 16′ simply ignores any results from the comparator 44 and does not perform any type of error comparison before retiring the outputs of the FPUs 40A and 40B. As a result, there is no degradation in the speed of the microprocessor 16′.

Referring to FIGS. 2 and 3, the mode register 38 determines whether the microprocessors 16 and 16′ operate in the performance mode or the HA mode based on the value in the mode register. However, the value in the mode register 38 may be set in a number of ways. For example, an operating system (OS) may set the value in the mode register 38 in the microprocessors 16 and 16′. The OS may determine when to set the value in the mode register 38 on an instruction-by-instruction basis or a program-by-program basis. Specifically, the OS may have access to a table that specifies the mode register setting for the microprocessors 16 and 16′ when each of a number of programs are running or when each of a combination of programs are running. As a result, the OS is able to automatically determine when the microprocessors 16 and 16′ operate in the performance mode or the HA mode.

Alternatively, the value in the mode register 38 may be set by user control. A user may determine through a user interface that specific programs require the microprocessors 16 and 16′ to run in either the HA mode or the performance mode, and set the value in the mode register 38 accordingly through the user interface. In addition, the user may modify the table described above that specifies the mode register settings for specific programs through the user interface. In this way, the user can manually set the value in the mode register 38 and override the OS so that a program is forced to run in either the HA mode or the performance mode.

In an alternative embodiment, the microprocessor 16, 16′ may include other mode registers in addition to the mode register 38 in order to incorporate different levels of HA operation. For example, a second mode register may be used to implement error correction coding (ECC) on all data or on data coming from certain units within the microprocessors 16 and 16′. A third mode register may be used to implement parity checking again on all data or on data coming from certain units within the microprocessors 16 and 16′. Besides being independently controllable using separate mode registers, these different levels of HA operation may also be designed to be implemented in various combinations or sub-combinations.

In another embodiment, the computing circuit 12 in FIG. 1 may include multiple microprocessors. For example, in a computing circuit having two or more microprocessors, one of the microprocessors may be set to operate in the HA mode and another one of the microprocessors may be set to operate in the performance mode. As a result, if multiple programs are running simultaneously where one program runs in the HA mode and another program runs in the performance mode, the OS may send each program to the appropriate microprocessor. Similarly, if a single program includes HA instructions to be executed in the HA mode and other instructions to be executed in the performance mode, the OS may send each type of instruction to the appropriate microprocessor. These instructions are not coded differently, but the OS recognizes which instructions need to be sent to which microprocessor. Again, this may be done with a table that corresponds certain programs or sets of instructions to a particular mode. It should be noted that in this embodiment with multiple multiprocessors, the microprocessors may be permanently configured—one in the HA mode and another in the performance mode. It is not necessary that the microprocessors be configurable with a mode register.

Still referring to FIGS. 2 and 3, the microprocessors 16 and 16′ use a built-in hardware comparator 44 to perform the comparison of actual and redundant FPU results. In an alternative embodiment, the microprocessors 16 and 16′ may instead insert a comparison instruction that immediately follows the actual and redundant FPU instructions. The actual FPU result is not retired until the comparison instruction is completed and no error is signaled. This comparison instruction has the benefit of not requiring any additional hardware such as a comparator, but it does reduce the performance of the microprocessors 16 and 16′.

In another embodiment, the microprocessors 16 and 16′ may insert a comparison instruction at an optimal location within the instruction flow. An advantage of this embodiment is that the comparison instruction is not required to immediately follow the actual and redundant FPU instructions. Instead, the microprocessors 16 and 16′ are allowed to pre-fetch a number of instructions to determine the least costly location to insert the compare instruction. The cost of the location within the pre-fetched instruction flow may be determined as a function of resource utilization, performance and coverage. The actual FPU result is not retired until the comparison instruction is completed and no error is signaled.

In another embodiment, the microprocessors 16 and 16′ may retire the actual FPU results before a comparison operation is completed. This increases the processing speed of the microprocessors 16 and 16′ because the results of the FPU instructions are retired immediately upon their completion. If no error is detected when the comparison is completed, then the instruction flow continues as usual. However, if an error is detected, then the system reverts back to a known “good” state and resumes processing from there. Assuming the frequency of errors detected from the comparison is low, this embodiment potentially experiences less performance degradation than the two embodiments above.

Therefore, a standard program does not need to be rewritten or recompiled in order for it to take advantage of the microprocessors 16 and 16′ operating in HA mode. While in the HA mode, the microprocessors 16 and 16′ implement the fault tolerant operations in hardware, and as a result, these operations are transparent to the software program. In addition, because the operation of the microprocessors 16 and 16′ in either HA mode or performance mode is configurable, high performance and increased fault-tolerance may both be maintained in the same computer system with the same microprocessor and the same program.

From the foregoing it will be appreciated that, although specific embodiments of the invention have been described herein for purposes of illustration, various modifications may be made without deviating from the spirit and scope of the invention.

What is claimed is:

1. A microprocessor, comprising:
a plurality of execution units of a same type; and
a first register operable to select between a first and a second mode of operation, wherein the microprocessor utilizes at least one of the execution units as a redundant execution unit during the first mode of operation and utilizes none of the execution units as a redundant execution unit during the second mode of operation.

2. The microprocessor of claim 1, wherein the execution units comprise floating point units.

3. The microprocessor of claim 1, further comprising a comparator operable to compare an output of an execution unit to an output of a corresponding redundant execution unit during the first mode of operation.

4. The microprocessor of claim 1, wherein a comparison instruction causes a comparison of an output of an execution unit to an output of a corresponding redundant execution unit during the first mode of operation.

5. The microprocessor of claim 1, wherein one of the execution units is utilized as a redundant execution unit during the first mode of operation and is idle during the second mode of operation.

6. The microprocessor of claim 5, wherein the one of the execution units is not accessible by an operating system.

7. The microprocessor of claim 1, wherein a value in the first register is set by an operating system executed by the microprocessor.

8. The microprocessor of claim 1, wherein a value in the first register is set by a user.

9. The microprocessor of claim 1, further comprising a second register operable to select between a third and a fourth mode of operation, wherein the microprocessor utilizes error correction code (ECC) during the third mode of operation and does not utilize ECC during the fourth mode of operation.

10. The microprocessor of claim 1, further comprising a third register operable to select between a fifth and a sixth mode of operation, wherein the microprocessor utilizes parity checking during the fifth mode of operation and does not utilize parity checking during the sixth mode of operation.

11. A microprocessor, comprising:
an execution unit; and
a register operable to select between a first and a second mode of operation, wherein the microprocessor provides redundant instructions to the execution unit during the first mode of operation and does not provide redundant instructions to the execution unit during the second mode of operation.

12. A computer system, comprising:
a first microprocessor having a first execution unit and operable to provide redundant instructions to the first execution unit; and
a second microprocessor having a second execution unit operable to provide no redundant instructions to the second execution unit.

13. The computer system of claim 12, wherein the first microprocessor comprises a register operable to select between a first and a second mode of operation, wherein the first microprocessor provides redundant instructions to the first execution unit during the first mode of operation and does not provide redundant instructions to the first execution unit during the second mode of operation.

14. The computer system of claim 12, wherein each microprocessor comprises a plurality of execution units of a same type.

15. A method of executing instructions on a plurality of execution units of a same type in a microprocessor, comprising:
utilizing at least one of the execution units as a redundant execution unit when a first mode of operation is selected; and
utilizing none of the execution units as a redundant execution unit when a second mode of operation is selected.

16. The method of claim 15, wherein the execution units comprise floating point units.

17. The method of claim 15, further comprising comparing an output of an execution unit to an output of a corresponding redundant execution unit when the first mode of operation is selected.

18. The method of claim 15, wherein selecting the first and second modes of operation comprises setting a value in a register in the microprocessor.

19. The method of claim 18, wherein the value in the register is automatically set by an operating system.

20. A method of executing instructions on an execution unit in a microprocessor, comprising:
providing redundant instructions to the execution unit when a first mode of operation is selected; and
providing no redundant instructions to the execution unit when a second mode of operation is selected.
